(19) United States
(12) Patent Application Publication
(10) Pub. No.: US 2017/0229711 A1
(43) Pub. Date: Aug. 10, 2017

(54) POSITIVE ELECTRODE PLATE FOR NONAQUEOUS ELECTROLYTE ENERGY STORAGE DEVICE, AND NONAQUEOUS ELECTROLYTE ENERGY STORAGE DEVICE

(71) Applicant: GS Yuasa International Ltd., Kyoto-shi, Kyoto (JP)

(72) Inventors: Yuto YAMAKAWA, Kyoto (JP); Hidefumi HASEGAWA, Kyoto (JP); Yohei SHIBATA, Kyoto (JP); Shinya UEMATSU, Kyoto (JP)

(21) Appl. No.: 15/501,690

(22) PCT Filed: Aug. 6, 2015
(86) PCT No.: PCT/JP2015/003974

§ 371 Date: Feb. 3, 2017

(30) Foreign Application Priority Data
Aug. 11, 2014 (JP) 2014-163885
Aug. 11, 2014 (JP) 2014-163886

(51) Int. Cl. H01M 4/62; H01M 4/66; H01M 4/505; H01M 4/525; H01G 11/28; H01M 10/0525

(52) U.S. Cl. CPC H01M 4/623; H01G 11/28; H01M 10/0525; H01M 4/625; H01M 4/505; H01M 4/525; H01M 4/661; H01M 2004/028

(57) ABSTRACT

A purpose of the present invention is to provide a technique for still further improving safety by increasing the resistance change ratio in a high-temperature range in a nonaqueous electrolyte energy storage device, the internal resistance of which increases with an increase in internal temperature. In a positive electrode plate for nonaqueous electrolyte energy storage device, an intermediate layer containing an electrically conducting agent and a binder is provided between a positive electrode current collector and a positive composite layer, and as the binder in the intermediate layer, one having a mass average molecular weight larger than that of a binder in the positive composite layer is used. Consequently, the resistance change ratio in a high-temperature range can be increased.

### TECHNICAL FIELD

The present invention relates to a positive electrode plate for nonaqueous electrolyte energy storage device. The present invention also relates to a nonaqueous electrolyte energy storage device including the positive electrode plate for aqueous electrolyte energy storage device.

### BACKGROUND ART

Nonaqueous electrolyte energy storage devices such as nonaqueous electrolyte secondary batteries and lithium ion capacitors are commonly used as power supplies or auxiliary power supplies. Particularly, nonaqueous electrolyte secondary batteries are widely used as power supplies for electronic devices, automobiles and so on because they can be adapted to size reduction, weight reduction, thickness reduction, densification of energy and so on.

Nonaqueous electrolyte energy storage devices are required to have high safety in addition to excellent performance for charge-discharge characteristics, energy density and so on. Particularly, if a nonaqueous electrolyte energy storage device is overcharged due to failure, wrong operation, misuse or the like, the internal temperature of an energy storage device may increase to above a normal use temperature. Thus, a safety measure against an increase in temperature of a nonaqueous electrolyte energy storage device is particularly important.

Various safety measures against an increase in temperature of a nonaqueous electrolyte energy storage device have been heretofore studied. For example, Patent Document 1 reports that a thermally expandable microcapsule is included in an electrode composite layer or along an interface between the electrode composite layer and a current collector, whereby if the internal temperature of a battery increases, a non-conduction state can be established between an electrode active material and the current collector to prevent a thermal runaway in a battery reaction. Patent Document 2 reports that an electrically conducting agent, and an electrically conductive layer containing polyvinylidene fluoride containing an α-product and a β-product at a predetermined ratio is provided between a current collector and an electrode composite, whereby if the internal temperature of a battery increases, the internal resistance increases to cut off a current between the current collector and the electrode composite, so that overheating can be prevented.

### PRIOR ART DOCUMENTS

### Patent Documents

Patent Document 1: JP-A-2001-332245

Patent Document 2: JP-A-2012-104422

### SUMMARY OF THE INVENTION

### Problems to be Solved by the Invention

Recently, due to increasing demand for safety of nonaqueous electrolyte energy storage devices, development of a technique for still further improving safety of nonaqueous electrolyte energy storage devices has been desired. In the case where the internal resistance is increased at the time when the internal temperature of a nonaqueous electrolyte energy storage device increases as in Patent Documents 1 and 2, still higher safety is secured if the nonaqueous electrolyte energy storage device can be designed such that the ratio of change of a resistance value in a high-temperature range to a resistance value in a normal use temperature range (resistance increase ratio in a high-temperature range) increases, and further, the internal resistance increase starting temperature decreases. However, in Patent Documents 1 and 2, either a method for increasing the resistance change ratio in a high-temperature range or a method for decreasing the internal resistance increase starting temperature is not discussed. In Patent Document 2, it is required to adjust the α/β ratio in the polyvinylidene fluoride to a predetermined range, and therefore heat treatment of an electrically conductive layer is necessary, so that conditions for preparation of an electrode plate are limited.

An object of the present invention is to provide a technique for still further improving safety by increasing the resistance change ratio of a positive electrode plate for nonaqueous electrolyte energy storage device at a high temperature above a normal use temperature range.

### Means for Solving the Problems

The present inventors have extensively conducted studies for achieving the above-mentioned object, and resultantly found that when in a positive electrode plate for nonaqueous electrolyte energy storage device, an intermediate layer containing an electrically conducting agent and a binder is provided between a positive electrode current collector and a positive composite layer, and as the binder in the intermediate layer, one having a mass average molecular weight larger than that of a binder in the positive composite layer is used, the resistance change ratio in a high-temperature range can be increased, so that safety against an increase in internal temperature of a nonaqueous electrolyte energy storage device can be improved. The present inventors have also found that by using, as the binder in the intermediate layer, one having a mass average molecular weight of 540,000 or more, or one having a mass average molecular weight that is 1.9 or more times as large as that of the binder in the positive composite layer, the internal resistance increase starting temperature is decreased. The present invention has been completed by further conducting studies on the basis of the above-mentioned findings.

A positive electrode plate for nonaqueous electrolyte energy storage device according to one aspect of the present invention includes: a positive electrode current collector; a positive composite layer containing a positive active material and a binder; and an intermediate layer situated between the positive electrode current collector and the positive composite layer and containing an electrically conducting agent and a binder, wherein the mass average molecular weight of the binder in the intermediate layer is larger than the mass average molecular weight of the binder in the positive composite layer. According to the above-mentioned configuration, the resistance change ratio in a high-temperature range can be increased to improve safety.

In the positive electrode plate for nonaqueous electrolyte energy storage device according to one preferred aspect of the present invention, at least the intermediate layer, preferably each of the positive composite layer and the intermediate layer, contains polyvinylidene fluoride as a binder. In the positive electrode plate for nonaqueous electrolyte energy storage device according to one aspect of the present invention, the mass average molecular weight of the binder in the intermediate layer is 1.6 or more times as large as the mass average molecular weight of the binder in the positive composite layer. Further, in the positive electrode plate for nonaqueous electrolyte energy storage device according to one aspect of the present invention, the mass average molecular weight of the binder in the intermediate layer is 460,000 or more. According to the above-mentioned configuration, the resistance change ratio in a high-temperature range can be still more effectively increased.

A nonaqueous electrolyte energy storage device according to one aspect of the present invention includes the positive electrode plate for nonaqueous electrolyte energy storage device. Further, an energy storage device according to one aspect of the present invention includes the nonaqueous electrolyte energy storage device. According to the above-mentioned configuration, it is possible to provide a nonaqueous electrolyte energy storage device and an energy storage apparatus each having improved safety against an increase in internal temperature.

### Advantages of the Invention

According to the present invention, the resistance change ratio of a positive electrode plate for nonaqueous electrolyte energy storage device can be increased at a high temperature above a normal use temperature range.

### BRIEF DESCRIPTION OF THE DRAWINGS

FIG. 1: a view showing a cross-section structure of a positive electrode plate according to one aspect of the present invention.

FIG. 2: a schematic view of a rectangular nonaqueous electrolyte energy storage device as a nonaqueous electrolyte energy storage device according to one aspect of the present invention.

FIG. 3: a schematic view of an energy storage apparatus according to one aspect of the present invention.

### MODE FOR CARRYING OUT THE INVENTION

### 1. Positive Electrode Plate for Nonaqueous Electrolyte Energy Storage Device

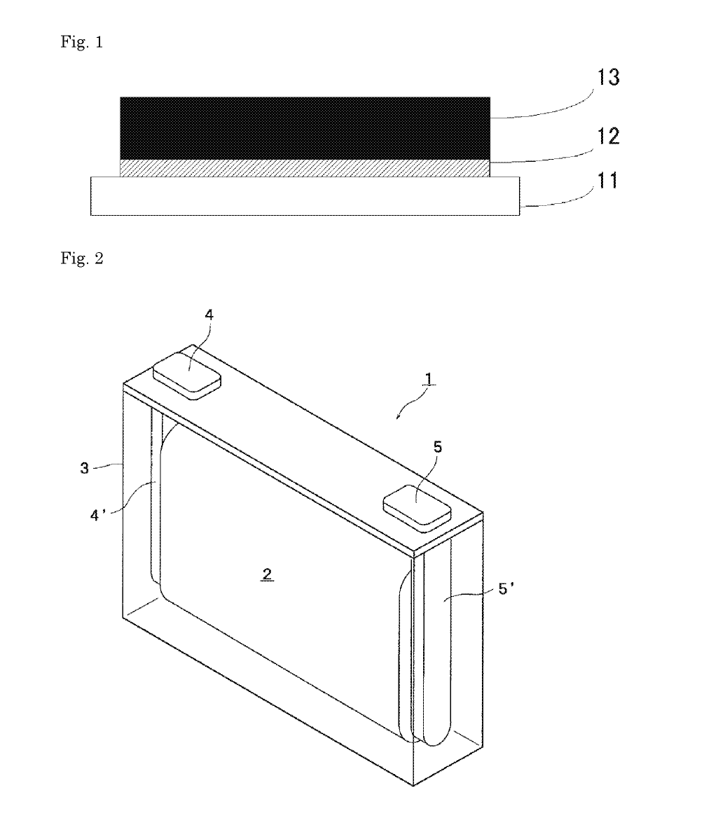

A positive electrode plate according to the present invention is a positive electrode plate to be used as a positive electrode for a nonaqueous electrolyte energy storage device. A sectional view of one aspect of the positive electrode plate according to the present invention is shown in FIG. 1. As shown in FIG. 1, the positive electrode plate according to the present invention has a structure including a positive electrode current collector 11; an intermediated layer 12 that is in contact with the positive electrode current collector; and a positive composite layer 13. In the positive electrode plate according to the present invention, the intermediate layer contains an electrically conducting agent and a binder, the positive composite layer contains a positive active material and a binder, and the mass average molecular weight of the binder in the intermediate layer is larger than the mass average molecular weight of the binder in the positive composite layer. Hereinafter, the positive electrode plate according to the present invention will be described in detail.

### [Positive Electrode Current Collector]

The positive electrode current collector to be used in the positive electrode plate according to the present invention is not particularly limited, and examples thereof include metal materials such as aluminum and alloys including the metal; and carbonaceous materials such as carbon cloth and carbon paper. Among them, aluminum is preferable.

### [Intermediate Layer]

In the positive electrode plate according to the present invention, the intermediate layer is disposed between the positive electrode current collector and the positive composite layer. The intermediate layer contains an electrically conducting agent and a binder.

The electrically conducting agent to be used in the intermediate layer is not particularly limited as long as it is an electrically conductive material, and examples thereof include carbon materials such as acetylene black, carbon black, ketjen black, carbon whiskers and carbon fibers; metal materials such as metal powders (e.g. aluminum, silver and gold powders) and metal fibers; and electrically conductive ceramic materials. Among these electrically conducting agents, carbon materials are preferably, and acetylene black is more preferable, from the viewpoint of coatability, electrical conductivity and so on. These electrically conducting agents may be used alone, or in combination of two or more thereof.

In the intermediate layer, the content of the electrically conducting agent is not particularly limited, and for example, the content of the electrically conducting agent based on the total amount of the intermediate layer is 30% by mass or more, preferably 30 to 90% by mass, more preferably 30 to 70% by mass. By setting the content of the electrically conducting agent to 30% by mass or more, the temperature at which the resistance of the positive electrode plate starts to increase can be decreased, so that safety can be still further improved. When the content of the electrically conducting agent is in a range as described above, the binder in the intermediate layer can be inhibited from outflowing to the positive composite layer in application of a positive composite layer paste, and therefore the resistance change ratio of the positive electrode plate can be still more effectively increased.

The bulky density of the electrically conducting agent is not particularly limited, but it is preferably 1.0 g/cm³ or less. When the bulk density of the electrically conducting agent is 1.0 g/cm³ or less, the electrically conducting agent is in contact with a larger amount of the binder, and thus the binder in the intermediate layer can be effectively inhibited from outflowing to the positive composite layer, so that the resistance change ratio of the positive electrode plate can be still more effectively increased. The bulk density of the electrically conducting agent is more preferably 0.6 g/cm³ or less, still more preferably 0.06 g/cm³ or less. The bulk density of the electrically conducting agent is preferably 0.01 g/cm³ or more for securing processability of the electrode. The bulk density is a value that is measured in accordance with the method described in JISK 1469.

The specific surface area of the electrically conducting agent is not particularly limited, but it is preferably 5.0 m²/g or more. The specific surface area of the electrically conducting agent is more preferably 30 m²/g or more, still more preferably 60 m²/g or more. When the specific surface area is in a range as described above, the contact area between the electrically conducting agent and the binder can be increased to effectively inhibit the binder in the intermediate layer from outflowing to the positive composite layer, so that the resistance change ratio of the positive electrode plate can be still more effectively increased. The specific surface area of the electrically conducting agent is preferably 1000 m²/g or less for securing processability of the electrode. The specific surface area of the electrically conducting agent is more preferably 200 m²/g or less, still more preferably 100 m²/g or less. The specific surface area is a BET specific surface area that is measured by a nitrogen adsorption method using a multi-point method (relative vapor pressure: 0.05 to 0.2).

The kind of the binder to be used in the intermediate layer is as described later.

In the intermediate layer, the content of the binder is not particularly limited, and for example, the content of the binder based on the total amount of the intermediate layer is 70% by mass or less, preferably 10 to 70% by mass, more preferably 30 to 70% by mass. When the content of the binder is in a range as described above, the resistance value in normal operation can be kept low, and therefore the resistance change ratio in a high-temperature range can be still more effectively increased.

The intermediate layer may contain additives such as a thickener and a filler as necessary in addition to the electrically conducting agent and the binder. The intermediate layer may contain a positive active material that is contained in the positive composite layer as long as the effect of the present invention is not hindered.

Examples of the thickener include polysaccharides such as carboxymethyl cellulose (CMC) and methyl cellulose. These thickeners may be used alone, or in combination of two or more thereof.

Examples of the filler include olefin-based polymers such as polypropylene and polyethylene, amorphous silica, alumina, zeolite, glass and carbon. These fillers may be used alone, or in combination of two or more thereof.

The thickness of the intermediate layer is, for example, 10 μM or less, preferably 5 μm or less, more preferably 3 μm or less. When the content of the binder is in a range as described above, the resistance value at a temperature in normal operation can be kept low, and therefore the resistance change ratio in a high-temperature range can be still more effectively increased. The lower limit of the thickness of the intermediate layer is not particularly limited, and it is, for example, 0.1 μm or more.

The intermediate layer can be formed by mixing constituent components to form a composite, mixing the composite with an organic solvent such as N-methylpyrrolidone or toluene, or water to prepare a paste, then applying the obtained paste onto the positive electrode current collector, drying the applied paste, and adjusting the density and the thickness by a roll press etc. As a method for the application, drying and so on, those that are well known may be employed.

### [Positive Composite Layer]

In the positive electrode plate according to the present invention, the positive composite layer is provided on the intermediate layer, and contains a positive active material and a binder.

The positive active material to be used in the positive composite layer is appropriately determined according to the kind of the nonaqueous electrolyte energy storage device including the positive electrode plate according to the present invention.

For example, when the positive electrode plate according to the present invention is used in a nonaqueous electrolyte energy storage device, the positive active material may be one capable of reversely adsorbing and releasing lithium ions, sodium ions and the like. The positive active material may be an inorganic compound or an organic compound. Specific examples of the inorganic compound to be used as a positive active material for use in a nonaqueous electrolyte lithium secondary battery include lithium-nickel composite oxides (e.g. LiₓNiO₂ and the like.), lithium-cobalt composite oxides (e.g. LiₓCoO₂ and the like), lithium nickel cobalt composite oxides (e.g. LiNi_{1-y}Co_{y}O₂ and the like), lithium nickel cobalt composite oxides (e.g. LiNi_{1-y}Co_{y}O₂ and the like), lithium nickel cobalt manganese composite oxides (e.g. LiNiₓCo_{y}Mn_{1-y-x}O₂, Li_{α}[NiₓCo_{y}Mn_{1-x-y}]_{1-α}O₂ and the like), spinel-type lithium manganese composite oxides (LiₓMn₂O₄ and the like), and lithium phosphorus oxides having an olivine structure (e.g. LiₓFePO₄, LiₓFe_{1-y}Mn_{y}PO₄, LiₓCOPO₄ and the like). Specific examples of the organic compound to be used as a positive active material for use in a nonaqueous electrolyte secondary battery include electrically conductive polymer materials such as polyaniline and polypyrrole, disulfide-based polymer materials and carbon fluoride.

In particular, use of a lithium nickel cobalt manganese composite oxide as a positive active material is preferable because a nonaqueous electrolyte energy storage device having a high discharge capacity and excellent high rate discharge characteristics can be obtained. Particularly, a lithium nickel cobalt manganese composite oxide represented by the general formula: LiNiₓCo_{y}Mn_{1-x-y}O₂ (0.3<x≦0.8) is preferable.

For example, when the positive electrode plate according to the present invention is used in a lithium ion capacitor, the positive active material is not particularly limited as long as it can be used as a positive active material for an electric double layer, and examples thereof include carbon materials such as active carbon in addition to the above-mentioned inorganic compounds and organic compounds.

In the positive electrode plate according to the present invention, the positive active materials may be used alone, or in combination of two or more thereof.

The content of the positive active material in the positive composite layer is not particularly limited, and for example, the content of the positive active material based on the total amount of the positive composite layer is 50 to 98.9% by mass, preferably 70 to 97.5% by mass, more preferably 85 to 97% by mass.

The kind of the binder to be used in the positive composite layer is as described later.

The content of the binder in the positive composite layer is not particularly limited, and for example, the content of the binder based on the total amount of the positive composite layer is 1 to 25% by mass, preferably 2 to 15% by mass, more preferably 2 to 7.5% by mass.

The positive composite layer may contain an electrically conducting agent as necessary in addition to the positive active material and the binder. The kind of the electrically conducting agent to be used in the positive composite layer is the same as the kind of the electrically conducting agent blended in the intermediate layer. Among these electrically conducting agents, acetylene black is preferable from the viewpoint of electron conductivity and coatability.

When the positive composite layer contains an electrically conducting agent, the content of the electrically conducting agent is not particularly limited, and for example, the content of the electrically conducting agent based on the total amount of the positive composite layer is 0.1 to 25% by mass, preferably 0.5 to 15% by mass, more preferably 1 to 7.5% by mass.

The positive composite layer may further contain additives such as a thickener and a filler as necessary. The kinds of the additives are the same as the kinds of the additives blended in the intermediate layer.

The mass of the positive composite layer per unit area is not particularly limited, and for example, it is 0.5 to 2.5 g/100 cm², preferably 1.5 to 2.5 g/100 cm². When the mass of the positive composite layer per unit area is in a range as described above, the positive electrode plate has excellent processability, so that it is possible to provide a nonaqueous electrolyte energy storage device having well balanced energy density, charge-discharge rate characteristics and so on.

The positive composite layer can be formed by mixing constituent components with an organic solvent such as N-methylpyrrolidone or toluene, or water to prepare a paste, then applying the obtained paste onto the intermediate layer, drying the applied paste, and adjusting the density and the thickness of a negative composite layer by a roll press etc. As a method for the application, drying and so on, those that are well known may be employed.

### [Binder Contained in Intermediate Layer and Positive Composite Layer]

For the kind of the binder to be used in the positive composite layer, the binder may be one that can be used as a binding agent, and examples thereof include polyvinylidene fluoride (PVDF), polytetrafluoroethylene (PTFE), copolymers of polyvinylidene fluoride such as vinylidene fluoride-hexafluoropropylene copolymers, styrene-butadiene rubber (SBR), polyacrylonitrile and fluorine rubber. These binders may be used alone, or in combination of two or more thereof.

The kind of the binder to be used in the intermediate layer in the present invention is not particularly limited, and examples thereof include fluorine-containing resins such as polyvinylidene fluoride (PVDF), copolymers of polyvinylidene fluoride such as vinylidene fluoride-hexafluoropropylene copolymers, and polytetrafluoroethylene (PTFE). Among them, polyvinylidene fluoride and polyvinylidene fluoride-containing copolymers are preferable. These binders may be used alone, or in combination of two or more thereof.

The kinds of the binders to be used in the intermediate layer and the positive composite layer may be identical to each other, or mutually different, but for still more effectively increasing the resistance change ratio in a high-temperature range, it is preferable that the intermediate layer contains polyvinylidene fluoride, and it is more preferable that both the intermediate layer and the positive composite layer contain polyvinylidene fluoride.

As the binder contained in the intermediate layer, one having a mass average molecular weight larger than that of the binder contained in the positive composite layer is used in the positive electrode plate according to the present invention. When as the binder contained in the intermediate layer, one having a mass average molecular weight larger than that of the binder contained in the positive composite layer is employed, the resistance change ratio in a high-temperature range can be increased. Although not wishing to be bounded by limited understandings, such a mechanism of action in the effect of the present invention may be considered as follows. Since the binder contained in the intermediate layer has an average molecular weight larger than the binder contained in the positive composite layer, solubility in a solvent (N-methylpyrrolidone, water or the like) that is used in a positive composite layer forming paste to be used in production is reduced, so that even when the positive composite layer forming paste is applied onto the intermediate layer, defects in the intermediate layer (mixing of the intermediate layer with the positive composite layer, elution of the binder in the intermediate layer to the positive composite forming paste, and so on) hardly occur. If the nonaqueous electrolyte energy storage device comes into a high-temperature state due to some abnormality such as overcharge, the resistance of the electrode easily increases in the intermediate layer.

For more effectively increasing the resistance change ratio in a high-temperature range, the mass average molecular weight of the binder contained in the intermediate layer is preferably as large as 1.6 or more times, more preferably 1.6 to 5.0 times as large as the mass average molecular weight of the binder contained in the positive composite layer. Particularly when the mass average molecular weight of the binder contained in the intermediate layer is 1.9 or more times, preferably 1.9 to 5.0 times, more preferably 2.2 to 4.0 times as large as the mass average molecular weight of the binder contained in the positive composite layer, the internal resistance increase starting temperature can be decreased while the resistance change ratio in a high-temperature range is increased.

The mass average molecular weight of the binder contained in the intermediate layer is not particularly limited as long as it is larger than the mass average molecular weight of the binder contained in the positive composite layer, but for more effectively increasing the resistance change ratio in a high-temperature range, the mass average molecular weight of the binder contained in the intermediate layer is preferably 460,000 or more, more preferably 460,000 to 1,000,000. Particularly when the mass average molecular weight of the binder contained in the intermediate layer is 540,000 or more, preferably 540,000 to 1,000,000, more preferably 630,000 to 1,000,000, the internal resistance increase starting temperature can be decreased while the resistance change ratio in a high-temperature range is increased.

The mass average molecular weight of the binder contained in the positive composite layer is not particularly limited as long as it is larger than the mass average molecular weight of the binder contained in the intermediate layer, but for more effectively increasing the resistance change ratio in a high-temperature range, and more effectively decreasing the internal resistance increase starting temperature, the mass average molecular weight of the binder contained in the positive composite layer is preferably 630,000 or less, more preferably 280,000 to 540,000, still more preferably 280,000 to 460,000.

In this specification, the mass average molecular weight of the binder is a value that is determined with polystyrene used as a molecular weight standard substance by a GPC (gel permeation chromatography) method in accordance with JIS K 7252-2. When two or more binders are used in combination in the intermediate layer and/or the positive composite layer, the mass average molecular weight of the binder is a mass average molecular weight of all the binders contained in the layers.

Use of a copolymer of polyvinylidene fluoride as the binder to be used in the intermediate layer is preferable because the internal resistance increase starting temperature can be considerably decreased while a function as a binder is secured. Although not wishing to be bounded by limited understandings, the mechanism of action of decreasing the internal resistance increase starting temperature by a copolymer of polyvinylidene fluoride may be considered as follows. When a heterogenous monomer is introduced into polyvinylidene fluoride, the crystallinity of the polyvinylidene fluoride is reduced, so that an amorphous part is generated. The amorphous part is easily stabilized with a solvent for a nonaqueous electrolyte, and more easily captures a solvent as compared to polyvinylidene fluoride having high crystallinity at the same temperature. Thus, the resistance increase starting temperature may be decreased by including a copolymer of polyvinylidene fluoride in the intermediate layer.

The kind of monomer other than vinylidene fluoride, which is contained in the copolymer of polyvinylidene fluoride, is not particularly limited, and examples thereof include fluorine-containing monomers such as hexafluoropropylene (HFP) and tetrafluoroethylene (TFE). In the copolymer of polyvinylidene fluoride, the monomers other than vinylidene fluoride may be contained alone, or in combination of two or more thereof.

Specific examples of the copolymer of polyvinylidene fluoride include vinylidene fluoride-hexafluoropropylene copolymers, vinylidene fluoride-tetrafluoroethylene copolymers and vinylidene fluoride-tetrafluoroethylene-hexafluoropropylene copolymers. Among these copolymers of polyvinylidene fluoride, vinylidene fluoride-hexafluoropropylene copolymers and vinylidene fluoride-tetrafluoroethylene-hexafluoropropylene copolymers are preferable, with vinylidene fluoride-tetrafluoroethylene-hexafluoropropylene copolymers being more preferable, for more effectively decreasing the resistance increase starting temperature.

A functional group may be introduced in the copolymer of polyvinylidene fluoride as necessary. The functional group that can be introduced into the copolymer of polyvinylidene fluoride is not particularly limited, and examples thereof include a carboxyl group, a carbonyl group, a sulfonic acid group, a nitro group, an acetyl group, a hydroxy group and an amino group. These functional groups may be introduced alone, or in combination of two or more thereof.

### [Porosity of Positive Electrode Plate]

The porosity of the positive electrode plate is not particularly limited, and for example, it is 15 to 45%, preferably 20 to 35%. When the porosity is in a range as described above, it is possible to provide a nonaqueous electrolyte energy storage device having excellent electrolyte solution filling property, and well balanced energy density, charge-discharge rate characteristics and so on. The positive electrode plate is taken out in a discharged state, and the porosity of the positive electrode plate is measured using a silver porosimeter. The porosity of the positive electrode plate may be adjusted by controlling the applied weight and thickness of each of the intermediate layer and the positive composite layer.

### 2. Nonaqueous Electrolyte Energy Storage Device

The nonaqueous electrolyte energy storage device according to the present invention includes the positive electrode plate. By using the positive electrode plate in the nonaqueous electrolyte energy storage device as described above, the resistance change ratio in a high-temperature range can be increased, so that high safety can be imparted.

Examples of the specific form of the nonaqueous electrolyte energy storage device according to the present invention include nonaqueous electrolyte secondary batteries and lithium ion capacitors.

For functioning as a nonaqueous electrolyte energy storage device, the nonaqueous electrolyte energy storage device according to the present invention may include, in addition to the positive electrode plate, a negative electrode plate, a nonaqueous electrolyte, and a separator disposed between the positive electrode plate and the negative electrode plate. Hereinafter, the members that form the nonaqueous electrolyte energy storage device according to the present invention will be described in detail.

### [Negative Electrode Plate]

The negative electrode plate may have a negative composite layer formed on a negative electrode current collector.

The negative electrode current collector to be used in the negative plate electrode is not particularly limited, and examples thereof include metal materials such as copper, nickel, stainless steel, nickel-plated steel and chromium-plated steel. Among them, copper is preferable from the viewpoint of ease of processing and a cost.

The negative composite layer contains a negative active material. The negative active material is not particularly limited as long as it is capable of reversibly absorbing and releasing lithium ions, sodium ions and so on. Specific examples of the negative active material to be used in the nonaqueous electrolyte secondary battery include amorphous carbon such as hardly graphitizable carbon (hard carbon) and easily graphitizable carbon (soft carbon); graphite; alloys of lithium and a metal such as Al, Si, Pb, Sn, Zn or Cd; silicon oxide; tungsten oxide; molybdenum oxide; iron sulfide; titanium sulfide; and lithium titanate. Specific examples of the negative active material to be used in the lithium ion capacitor include active carbon. These negative active materials may be used alone, or in combination of two or more thereof.

The negative composite layer may contain additives such as an electrically conducting agent, a binder, a thickener and a filler as necessary in addition to the negative active material. The kinds of the additives are the same as the kinds of the additives blended in the positive composite layer.

The negative electrode plate can be formed by mixing constituent components of the negative composite layer with an organic solvent such as N-methylpyrrolidone or toluene, or water to prepare a paste, then applying the obtained paste onto the negative electrode current collector, drying the applied paste, and adjusting the density and the thickness of a negative composite layer by a roll press etc. As a method for the application, drying and so on, those that are well known may be employed.

### [Nonaqueous Electrolyte]

The nonaqueous solvent to be used in the nonaqueous electrolyte is not particularly limited, and examples thereof include cyclic carbonic acid esters such as propylene carbonate, ethylene carbonate, butylene carbonate, chloroethylene carbonate and vinylene carbonate; cyclic esters such as γ-butyrolactone and γ-valerolactone; chain carbonates such as dimethyl carbonate, diethyl carbonate and ethyl methyl carbonate; chain esters such as methyl formate, methyl acetate and methyl butyrate; tetrahydrofuran or derivatives thereof ethers such as 1,3-dioxane, 1,4-dioxane, 1,2-dimethoxyethane, 1,4-dibutoxyethane and methyl diglyme; nitriles such as acetonitrile and benzonitrile; dioxolane or derivatives thereof and ethylene sulfide, sulfolane, sultone or derivatives thereof. These nonaqueous solvents may be used alone, or in combination of two or more thereof.

The support salt to be used in the nonaqueous electrolyte is not particularly limited, and a lithium salt which is generally used in a nonaqueous electrolyte secondary battery and which is stable in a wide potential range can be used. Examples of the support salt include LiBF₄, LiPF₆, LiClO₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiB(C₂O₄)₂ and LiC(C₂F₅SO₂)₃. These support salts may be used alone, or in mixture of two or more thereof. The content of the support salt in the nonaqueous electrolyte is not particularly limited, and may be appropriately determined according to the kind of a support salt, a nonaqueous solvent or the like to be used, and for example, it is 0.1 to 5.0 mol/L, preferably 0.8 to 2.0 mol/L.

### [Separator]

The separator is not particularly limited as long as it has insulation property, and a microporous film, a nonwoven fabric or the like is used. Examples of the material that forms the separator include polyolefin-based resins such as polyethylene and polypropylene, polyimide-based resins and celluloses. These materials may be used alone, or in combination of two or more thereof.

### [Other Constituent Members]

In the nonaqueous electrolyte energy storage device, other constituent elements include a terminal, an insulating plate and a case, and as these constituent elements in the nonaqueous electrolyte energy storage device according to the present invention, those that have been used heretofore may be used as they are.

### [Structure of Nonaqueous Electrolyte Energy Storage Device]

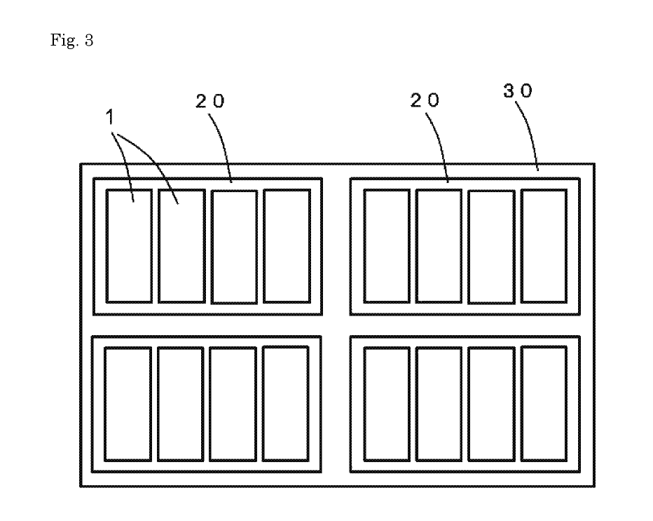

FIG. 2 is a schematic view of a rectangular nonaqueous electrolyte energy storage device 1 as one embodiment of the nonaqueous electrolyte energy storage device according to the present invention. FIG. 2 transparently shows the inside of a container. The nonaqueous electrolyte solution energy storage device 1 shown in FIG. 2 has an electrode group 2 stored in an outer package 3. The electrode group 2 is formed by winding a positive electrode for nonaqueous electrolyte energy storage device and a negative electrode containing a negative active material with a separator interposed therebetween. The positive electrode is electrically connected to a positive electrode terminal 4 through a positive electrode lead 4′, and the negative electrode is electrically connected to a positive electrode terminal 5 through a negative electrode lead 5′.

The configuration of the nonaqueous electrolyte solution energy storage device according to the present invention is not particularly limited, and mention is made of cylindrical, prismatic (rectangular) and flat energy storage devices as examples.

### [Production Method]

The nonaqueous electrolyte energy storage device according to the present invention is produced by sandwiching a separator between a positive electrode plate and a negative electrode plate, and impregnating these electrodes and the separator with a nonaqueous electrolyte.

### 3. Energy Storage Apparatus

An energy storage apparatus according to the present invention includes the nonaqueous electrolyte energy storage device. In the present invention, the energy storage apparatus is an apparatus which supplies power to a power source operated by electric energy, or is supplied with power from the power source using the nonaqueous electrolyte energy storage device. The energy storage apparatus may include, in addition to the nonaqueous electrolyte energy storage device, an electronic control unit for controlling the nonaqueous electrolyte energy storage device as necessary.

The energy storage apparatus according to the present invention may include one nonaqueous electrolyte energy device as described above, or a plurality of nonaqueous electrolyte energy storage devices as described above.

FIG. 3 shows one embodiment of the energy storage apparatus according to the present invention. In FIG. 3, an energy storage apparatus 30 includes a plurality of energy storage units 20. Each energy storage unit 20 includes a plurality of nonaqueous electrolyte solution energy storage devices 1. The energy storage apparatus 30 can be mounted as an automotive power supply for an electric vehicle (EV), a hybrid electric vehicle (HEV), a plug-in hybrid electric vehicle (PHEV) or the like.

### Examples

Hereinafter, the present invention will be described in detail by way of examples, but the present invention is not construed to be limited to these examples. The mass average molecular weight of PVDF which will be shown below is a value measured by a GPC method in accordance with JIS K 7252-2. The electrically conducting agent (acetylene black) used in the following examples has a bulk density of 0.04 g/ml as measured in accordance with the method described in JIS K 1469, and a BET specific surface area of 68 m²/g as measured by a nitrogen adsorption method using a multi-point method (relative vapor pressure: 0.05 to 0.2).

### 1. Production of Positive Electrode Plate for Lithium Secondary Battery

An intermediate layer paste containing an electrically conducting agent (acetylene black), a binder and a nonaqueous solvent (N-methylpyrrolidone; NMP) was prepared. Appropriate amounts of two PVDFs having mass average molecular weights of 280,000 and 630,000, respectively, were mixed to prepare PVDF having a mass average molecular weight as shown in Table 1, and the PVDF was used as a binder in Examples 1 and 2. In Example 3, PVDF having a mass average molecular weight of 630,000 was used as a binder. In Example 4, a vinylidene fluoride-hexafluoropropylene copolymer P (VDF-HFP) having a mass average molecular weight of 1,000,000 was used as a binder. In Comparative Example 1, PVDF having a mass average molecular weight of 280,000 was used as a binder. In the intermediate layer paste, the mass ratio of the electrically conducting agent and the binder was set to 30:70 in Examples 1 to 4 and Comparative Example 1, 10:90 in Reference Example 1, and 20:80 in Reference Example 2. In Reference Example 3, a vinylidene fluoride-tetrafluoroethylene-hexafluoropropylene copolymer (P (VDF-TEF-HFP)) having a mass average molecular weight of 500,000 was used as a binder, and the mass ratio of the electrically conducting agent and the binder was set to 30:70. The intermediate layer paste was prepared by passing through a mixing step using a multi-blender mill while adjusting the solid concentration to 14% by mass by adjusting the amount of NMP. The intermediate layer paste was applied to one surface of a 20 μm-thick current collector (aluminum foil), and dried by evaporating NMP in a thermostatic bath at 100° C., so that a current collector including an intermediate layer was prepared.

Next, a positive composite paste containing a positive active material (lithium nickel manganese cobalt composite oxide (LiNi_{1/3}Mn_{1/3}Co_{1/3}O₂)), an electrically conducting agent (acetylene black), a binder (PVDF) and a nonaqueous solvent (NMP) was prepared. Here, the PVDF used in the positive composite paste had an average molecular weight of 280,000. In the positive composite paste, the mass ratio of the active material, the binder and the electrically conductive agent was set to 94:3:3 (in terms of a solid content). The positive composite paste was prepared by passing through a mixing step using a multi-blender mill while adjusting the solid content to 30% by mass by adjusting the amount of NMP. The positive composite paste was applied onto the intermediate layer, and dried by evaporating NMP in a thermostatic bath at 100° C. Next, the current collector was roll-pressed, and cut into a circular shape with a diameter of 1.4 cm to prepare a positive electrode plate. In the positive electrode plate, the thickness of the intermediate layer was 5 μm, the applied mass of the positive composite layer was 2.0 g/100 cm², and the porosity was 30%. The positive electrode plate was vacuum-dried (at a temperature of 100° C. for 14 hours), and then used for resistance measurement as described later.

### 2. Measurement of Electrode Resistance

### Method for Preparing Resistance Measuring Cell

Tomuseru (manufactured by Nippon Tomuseru Co., Ltd.) was used for measuring the resistance of the electrode. Tomuseru included a lower lid, an electrode plate, a separator, an electrode plate, a disc, a flat spring and an upper lid. At the inside of a packing existing on the stainless lower lid, one separator was placed so as to be sandwiched between two positive electrode plates immersed in a nonaqueous electrolyte beforehand. Here, the active material-applied surfaces of the positive electrode plates faced each other. Thereafter, the stainless disc and flat spring were placed, and finally the stainless upper lid was placed, and then fastened with a nut to be fixed. Here, the fastening pressure was set to 0.5 Nm.

The following nonaqueous electrolyte and separator were used.

### [Nonaqueous Electrolyte]

A nonaqueous electrolyte was prepared by dissolving lithium phosphate hexafluoride (LiPF₆) as a fluorine-containing electrolyte salt in a concentration of 1.0 mol/l in a mixed solvent obtained by mixing ethylene carbonate (EC), ethyl methyl carbonate (EMC) and dimethyl carbonate (DMC) at a volume ratio of 30:35:35. The water content in the nonaqueous electrolyte was set to less than 50 ppm.

### [Separator]

As the separator, a 30 μm-thick polyethylene microporous film having an air resistance of about 600 seconds/100 cc and processed into a circular shape with a diameter of 1.6 cm was used.

### Method for Measuring Electrode Resistance

A measuring cell was placed in a thermostatic bath, and the alternating-current resistance at 1 kHz (amplitude: 5 mV) was measured while the temperature of the thermostatic bath was elevated at 3° C./min. The temperature given by a temperature measuring terminal placed on the upper surface of the cell was recorded as the cell temperature. For measurement of the alternating-current resistance, an apparatus made by combining Model 1287 Potentio/Galvanostat and Model 1260 Frequency Response Analyzer each manufactured by Solartron Company was used.

From the measured resistance value, the resistance increase starting temperature and the resistance change ratio were determined. The resistance increase starting temperature was determined as a temperature at which the resistance value reaches 150% where the resistance value showing the lowest value (resistance value at 80° C. or lower) is 100%. The resistance change ratio was determined as a relative ratio of the resistance value at the time when the temperature reaches 120° C. where the resistance value showing the lowest value (resistance value at 80° C. or lower) is 100%.

### 3. Measurement Results

The obtained results are shown in Table 1. From the results, it has been confirmed that when the binder contained in the intermediate layer has a mass average molecular weight larger than that of the binder contained in the positive composite layer (Examples 1 to 4), the resistance at the time when the temperature becomes high increases, so that the resistance change ratio increases. Further, it has become evident that when the mass average molecular weight of the binder contained in the intermediate layer is 540,000 or more, or 1.9 or more times as large as the mass average molecular weight of the binder contained in the positive composite layer (Examples 2 to 4), the resistance starting temperature decreases.

The resistance increase starting temperature in Reference Example 3 was measured, and the result showed that the resistance increase starting temperature was 74° C. From the results in Example 4 and Reference Example 3, it has been found that when the intermediate layer contains a copolymer of PVDF, the decrease in resistance starting temperature is large. Particularly, when the intermediate layer contained P(VDF-TEF-HFP), the decrease in resistance starting temperature was considerably large, so that safety against heat generation was considerably high.

TABLE 1

| | | | Intermediate layer | | | Resistance | |
|---|---|---|---|---|---|---|---|
| | Positive composite layer | | | | Mass ratio of | increase | Resistance |
| | | Mass average | | Mass average | electrically | starting | change |
| | Kind of | molecular | Kind of | molecular | conducting | temperature | ratio |
| | binder | weight of binder | binder | weight of binder | agent and binder | (° C.) | (%) |
| Comparative | PVDF | 280,000 | PVDF | 280,000 | 30:70 | 108 | 237 |
| Example 1 | | | | | | | |
| Reference | PVDF | 280,000 | PVDF | 280,000 | 10:90 | 116 | 233 |
| Example 1 | | | | | | | |
| Reference | PVDF | 280,000 | PVDF | 280,000 | 20:80 | 114 | 260 |
| Example 2 | | | | | | | |
| Example 1 | PVDF | 280,000 | PVDF | 460,000 | 30:70 | 109 | 311 |
| Example 2 | PVDF | 280,000 | PVDF | 540,000 | 30:70 | 105 | 336 |
| Example 3 | PVDF | 280,000 | PVDF | 630,000 | 30:70 | 102 | 381 |
| Example 4 | PVDF | 280,000 | P (VDF-HFP) | 1,000,000 | 30:70 | 97 | 265 |

### DESCRIPTION OF REFERENCE SIGNS

1 Nonaqueous electrolyte solution energy storage device
2 Electrode group
3 Outer package
4 Positive electrode terminal
4′ Positive electrode lead
5 Negative electrode terminal
5′ Negative electrode lead
11 Positive electrode current collector
12 Intermediate layer
13 Positive composite layer
20 Energy storage unit
30 Energy storage apparatus

1. A positive electrode plate for nonaqueous electrolyte energy storage device, comprising:
a positive electrode current collector;
a positive composite layer containing a positive active material and a binder; and
an intermediate layer situated between the positive electrode current collector and the positive composite layer and containing an electrically conducting agent and a binder,
wherein the mass average molecular weight of the binder in the intermediate layer is larger than the mass average molecular weight of the binder in the positive composite layer.

2. The positive electrode plate for nonaqueous electrolyte energy storage device according to claim 1 or 2, wherein the binder in the intermediate layer contains polyvinylidene fluoride.

3. The positive electrode plate for nonaqueous electrolyte energy storage device according to claim 1, wherein the binder in the intermediate layer contains a copolymer of polyvinylidene fluoride.

4. The positive electrode plate for nonaqueous electrolyte energy storage device according to claim 1, wherein the binder in the positive composite layer contains polyvinylidene fluoride.

5. The positive electrode plate for nonaqueous electrolyte energy storage device according to claim 1, wherein the mass average molecular weight of the binder in the intermediate layer is 1.6 or more times as large as the mass average molecular weight of the binder in the positive composite layer.

6. The positive electrode plate for nonaqueous electrolyte energy storage device according to claim 1, wherein the mass average molecular weight of the binder in the intermediate layer is 1.9 or more times as large as the mass average molecular weight of the binder in the positive composite layer.

7. The positive electrode plate for nonaqueous electrolyte energy storage device according to claim 1, wherein the mass average molecular weight of the binder in the intermediate layer is 460,000 or more.

8. The positive electrode plate for nonaqueous electrolyte energy storage device according to claim 1, wherein the bulk density of the electrically conductive material in the intermediate layer is 1.0 g/cm³ or less.

9. The positive electrode plate for nonaqueous electrolyte energy storage device according to claim 1, wherein the mass of the positive composite layer is 0.5 to 2.5 g/100 cm².

10. The positive electrode plate for nonaqueous electrolyte energy storage device according to claim 1, wherein the porosity of the positive composite layer is 15 to 45%.

11. A nonaqueous electrolyte energy storage device comprising the positive electrode plate for nonaqueous electrolyte energy storage device according to claim 1.

12. An energy storage apparatus comprising the nonaqueous electrolyte energy storage device according to claim 11.
